(19) United States
(12) Patent Application Publication
(10) Pub. No.: US 2022/0375273 A1
(43) Pub. Date: Nov. 24, 2022

(54) VEHICLE MANAGEMENT DEVICE AND VEHICLE MANAGEMENT METHOD

(71) Applicant: TOYOTA JIDOSHA KABUSHIKI KAISHA, Aichi-Ken (JP)

(72) Inventor: Yukinori II, Toyota-shi (JP)

(21) Appl. No.: 17/742,402

(22) Filed: May 12, 2022

(30) Foreign Application Priority Data
May 20, 2021 (JP) 2021-085562

(51) Int. Cl. G07C 5/00; G07C 5/08; G06Q 30/02; B60W 50/10

(52) U.S. Cl. CPC G07C 5/006; G07C 5/0816; G06Q 30/0208; B60W 50/10; B60W 2510/18; B60W 2552/20

(57) ABSTRACT

A vehicle management device includes: a sensor information acquisition section configured to acquire information from a sensor unit installed at a vehicle to be used by a user through a subscription service; a wear state estimation section configured to estimate a state of wear of an expendable part of the vehicle from the acquired information; a maintenance cost information acquisition section configured to acquire information regarding a maintenance cost of the expendable part from the estimated state of wear of the expendable part; and an incentive awarding section configured to award an incentive to the user of the vehicle according to the acquired maintenance cost information.

### CROSS-REFERENCE TO RELATED APPLICATION

This application is based on and claims priority under 35 USC 119 from Japanese Patent Application No. 2021-085562 filed on May 20, 2021, the disclosure of which is incorporated by reference herein.

### BACKGROUND

### Technical Field

The present disclosure relates to a vehicle management device and a vehicle management method.

### Related Art

Japanese Patent Application Laid-Open (JP-A) No. 2018-110029 discloses a lease vehicle shared usage system for acquiring lease fees of vehicles employed in car leasing.

In services in which a usage fee is paid for each predetermined period such as in car leasing and subscription services, the maintenance cost of expendable parts is often included in the usage fee. In such cases, there is room for improvement from the perspective of encouraging a user to use these expendable parts economically.

### SUMMARY

The present disclosure provides a vehicle management device and a vehicle management method that are capable of encouraging a user to use expendable parts economically.

A first aspect of the present disclosure is a vehicle management device including: a sensor information acquisition section configured to acquire information from a sensor unit installed at a vehicle to be used by a user through a subscription service; a wear state estimation section configured to estimate a state of wear of an expendable part of the vehicle from the acquired information; a maintenance cost information acquisition section configured to acquire information regarding a maintenance cost of the expendable part from the estimated state of wear of the expendable part; and an incentive awarding section configured to award an incentive to the user of the vehicle according to the acquired maintenance cost information.

In the vehicle management device according to the first aspect, the sensor information acquisition section acquires information from the sensor unit installed to the vehicle. The wear state estimation section estimates the state of wear of the expendable part of the vehicle from the acquired information. Note that “expendable part” referred to here includes parts such as tires, brake pads, brake rotors, engine oil, an air cleaner, a fuel filter, and so on.

The maintenance cost information acquisition section acquires information regarding the cost of maintenance of the expendable part from the estimated state of wear of the expendable part. Note that “maintenance cost” referred to here includes the cost of labor and replacement parts. The incentive awarding section awards the incentive to the user of the vehicle according to the acquired maintenance cost information. This enables the user of the vehicle to be encouraged to use the expendable part economically.

A second aspect of the present disclosure, in the first aspect, may further include: a standard cost information acquisition section configured to acquire information regarding a preset standard maintenance cost of the expendable part preset for each travel distance of the vehicle, wherein the incentive awarding section is configured to award the incentive according to a difference between the maintenance cost acquired by the maintenance cost information acquisition section and the standard maintenance cost.

In the vehicle management device according to the second aspect, the lower the acquired maintenance cost is with respect to the standard maintenance cost, the greater the incentive awarded to the user. This enables the user to be further encouraged to use the expendable part economically.

In a third aspect pf the present disclosure, in the first aspect or the second aspect, the incentive awarding section may be configured to lower a usage fee for the vehicle according to the acquired maintenance cost.

In the vehicle management device according to the third aspect, the usage fee for the vehicle is lowered by the incentive awarding section, thereby enabling the incentive to be given without the user being aware.

In a fourth aspect of the present disclosure, in the first aspect or the second aspect, the incentive awarding section may be configured to award points according to the acquired maintenance cost.

In the vehicle management device according to the fourth aspect, the user may use the points in a desired manner. For example, the points may be used to cover part of the cost when purchasing predetermined goods. Alternatively, the points may be exchanged for predetermined goods, or the points may be used to cover part or all of the usage fee.

In a fifth aspect of the present disclosure, in any one of the first aspect to the fourth aspect, the incentive awarded to the user by the incentive awarding section may be displayed on a display device inside a vehicle cabin of the vehicle, or on a portable terminal of the user.

In the vehicle management device according to the fifth aspect, by displaying the incentive for the user to see, the user is able to indirectly ascertain the state of wear of the expendable part.

A sixth aspect of the present disclosure is a vehicle management method including: acquiring information from a sensor unit installed at a vehicle to be used by a user through a subscription service; estimating a state of wear of an expendable part of the vehicle from the acquired information; acquiring a maintenance cost of the expendable part from the estimated state of wear of the expendable part; and awarding an incentive to the user of the vehicle according to the acquired maintenance cost.

As described above, the vehicle management device and the vehicle management method according to the present disclosure are capable of encouraging the user to use expendable parts economically.

### BRIEF DESCRIPTION OF THE DRAWINGS

Exemplary embodiment of the present disclosure will be described in detail based on the following figures, wherein:

FIG. 1 is a schematic diagram illustrating an overall configuration of a vehicle management system according to an exemplary embodiment;

FIG. 2 is a block diagram illustrating a hardware configuration of a vehicle management device according to an exemplary embodiment;

FIG. 3 is a block diagram illustrating a functional configuration of a vehicle management device according to an exemplary embodiment;

FIG. 4 is a flowchart illustrating an example of a flow of incentive awarding processing in an exemplary embodiment;

FIG. 5 is a flowchart illustrating an example of a flow of maintenance cost information acquisition processing in an exemplary embodiment; and

FIG. 6 is a flowchart illustrating an example of a flow of incentive awarding processing in a modified example.

### DETAILED DESCRIPTION

Explanation follows regarding a vehicle management system S including a vehicle management device 10 according to an exemplary embodiment, with reference to the drawings.

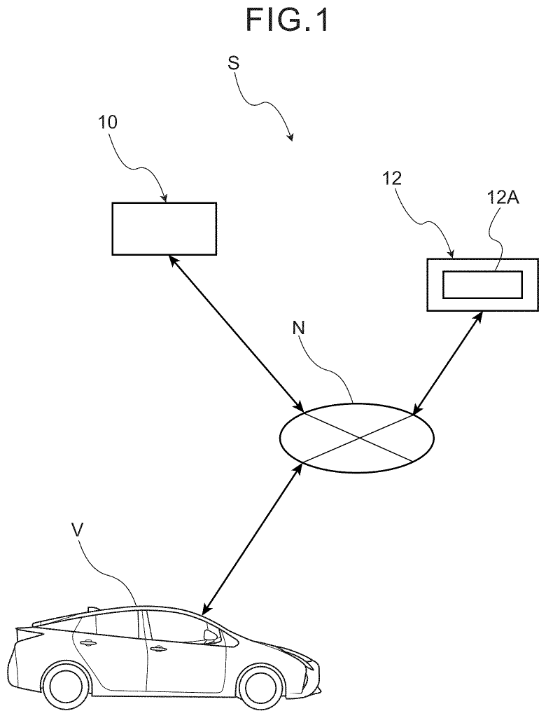

As illustrated in FIG. 1, the vehicle management system S of the present exemplary embodiment is configured including the vehicle management device 10, a server 12, and vehicles V. The vehicle management device 10, the server 12, and the vehicles V are connected over a network N. Note that although plural vehicles V are connected to the network N, only one vehicle V is illustrated in FIG. 1 for simplification. The vehicles V are vehicles are vehicles that are used by users through a subscription service.

The server 12 is a server owned by a company that manages the plural vehicles V. As an example, the server 12 of the present exemplary embodiment is owned by a company that runs the vehicle subscription service. A storage region 12A is provided to the server 12.

Note that the vehicle management device 10 of the present exemplary embodiment is configured to acquire information regarding a maintenance cost based on a state of wear of an expendable part of a vehicle V being used by a user through the subscription service, and to award an incentive to the user according to the acquired maintenance cost.

Hardware Configuration of Vehicle Management Device 10

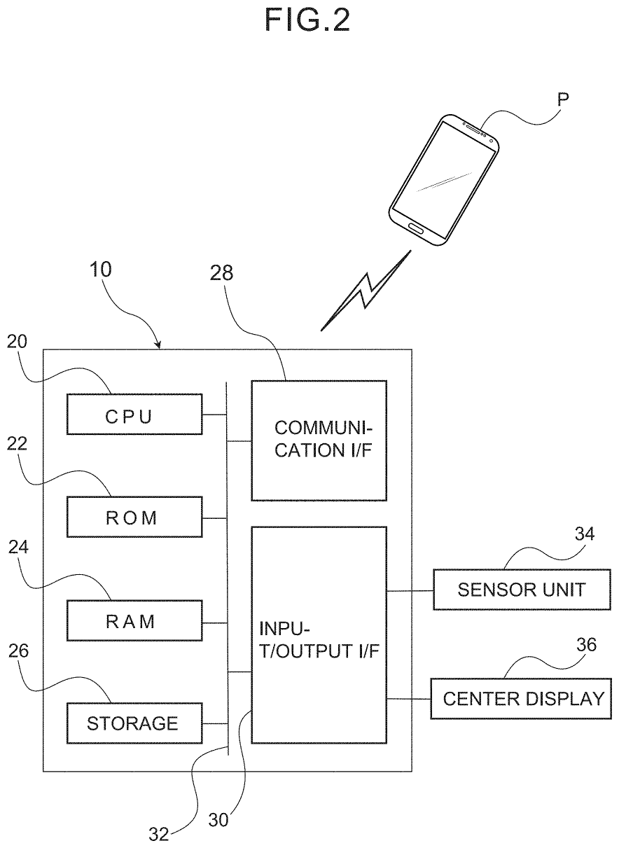

FIG. 2 is a block diagram illustrating a hardware configuration of the vehicle management device 10. As illustrated in FIG. 2, the vehicle management device 10 is configured including a central processing unit (CPU; processor) 20, read only memory (ROM) 22, random access memory (RAM) 24, storage 26, a communication interface (I/F) 28, and an input/output interface (I/F) 30. The respective configuration is connected so as to be capable of communicating with each other through a bus 32.

The CPU 20 is a central processing unit that executes various programs and controls various sections. Namely, the CPU 20 reads a program from the ROM 22 or the storage 26, and executes the program using the RAM 24 as a workspace. The CPU 20 controls the respective configuration and performs various computation processing according to the programs recorded in the ROM 22 or the storage 26.

The ROM 22 holds various programs and various data. The RAM 24 acts as a workspace to temporarily store programs or data. The storage 26 is configured by a hard disk drive (HDD) or a solid state drive (SSD), and holds various programs including an operating system, as well as various data. In the present exemplary embodiment, programs, various data, and so on for performing incentive awarding processing are held in the ROM 22 or the storage 26.

The communication I/F 28 is an interface enabling the vehicle management device 10 to communicate with the server 12, a portable terminal P, and other equipment. Protocol such as a controller area network (CAN), Ethernet (registered trademark), long term evolution (LTE), fiber distributed data interface (FDDI), or Wi-Fi (registered trademark) may be employed therefor. The portable terminal P is an example of a terminal carried by a user.

The input/output I/F 30 is electrically connected to a sensor unit 34 and a center display 36.

The sensor unit 34 includes plural sensors installed to each of the vehicles V, and is configured including sensors such as a vehicle speed sensor to detect the speed of the vehicle V, an acceleration sensor to detect an acceleration rate of the vehicle V, a steering angle sensor to detect a steering angle of the vehicle V, and a Global Positioning System (GPS) sensor. The sensor unit 34 also includes a load sensor that detects a total weight of occupants and their baggage inside the vehicle cabin.

The center display 36 is for example provided at a position at a front section of the vehicle cabin so as to be visible to the driver, and various information such as navigation system information and entertainment-related information is displayed thereon. In the present exemplary embodiment as an example, information relating to an incentive awarded to the user is displayed on the center display 36.

Functional Configuration of Vehicle Management Device 10

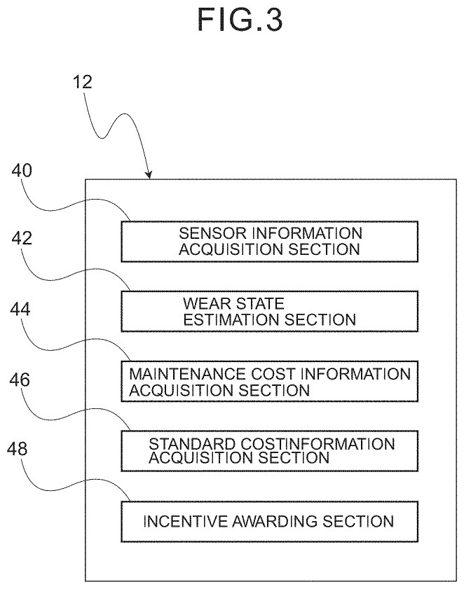

The vehicle management device 10 realizes various functionality using the above-described hardware resources. Explanation follows regarding the functional configuration realized by the vehicle management device 10, with reference to FIG. 3.

As illustrated in FIG. 3, the vehicle management device 10 is configured including an sensor information acquisition section 40, a wear state estimation section 42, a maintenance cost information acquisition section 44, a standard cost information acquisition section 46, and an incentive awarding section 48 as functional configuration. Note that this functional configuration is realized by the CPU 20 reading and executing the corresponding program stored in the ROM 22 or the storage 26.

The sensor information acquisition section 40 acquires predetermined information as detected during driving by the sensor unit 34 installed to the corresponding vehicle. Specifically, the sensor information acquisition section 40 acquires information relating to the speed, acceleration rate, and steering angle of the vehicle V from the vehicle speed sensor, the acceleration sensor, and the steering angle sensor. The sensor information acquisition section 40 also acquires information relating to the total weight of the occupants and their baggage inside the vehicle cabin from the load sensor. The sensor information acquisition section 40 also acquires information relating to the current position of the vehicle V from the GPS sensor.

The wear state estimation section 42 estimates a state of wear of expendable parts of the vehicle V from the information acquired by the sensor information acquisition section 40. Explanation follows regarding an example of a sequence in which a state of wear is estimated by the wear state estimation section 42.

In cases in which the wear state estimation section 42 is estimating the state of wear of brake pads and brake rotors serving as expendable parts, the wear state estimation section 42 estimates an operation amount (depression amount) of a brake pedal and an operation duration of the brake pedal based on the information from the vehicle speed sensor and the acceleration sensor. When this is performed, the wear state estimation section 42 may directly detect operating states of the brake pedal using a position sensor for the brake pedal.

The wear state estimation section 42 estimates the state of wear of the brake pads and the brake rotors from the operating states of the brake pedal. For example, data expressing a relationship between the operation amount of the brake pedal and the state of wear for the brake pads and brake rotors being used may be stored in advance in the server 12, and the wear state estimation section 42 may estimate the state of wear of the brake pads and the brake rotors by referencing this data.

In cases in which the wear state estimation section 42 is estimating the state of wear of an air cleaner serving as an expendable part, the wear state estimation section 42 may reference information from the GPS sensor and road surface data for the route traveled as pre-stored in the server 12 or the like. The wear state estimation section 42 estimates from the road surface data that wear is more advanced in cases of travel on an unsurfaced road than in cases of travel on surfaced roads only.

Note that as an example, the wear state estimation section 42 of the present exemplary embodiment outputs a level of wear of each of the expendable parts in the form of a value between 0 and 100, 100 indicating a state prior to use and 0 indicating a worn state requiring replacement. The level of wear of each of the expendable parts as estimated by the wear state estimation section 42 is stored in the storage region 12A of the server 12 or the like.

The maintenance cost information acquisition section 44 acquires information regarding a maintenance cost of each of the expendable parts from the estimated state of wear of the expendable part. In the present exemplary embodiment as an example, a table in which values for level of wear are associated with maintenance cost is stored for each of the expendable parts. The maintenance cost information acquisition section 44 acquires information regarding the maintenance cost by referencing these tables. Note that the maintenance cost includes a standard labor cost.

The standard cost information acquisition section 46 acquires information regarding a preset standard maintenance cost of each of the expendable parts preset for each travel distance of the vehicle V. Specifically, standard maintenance cost data for each of the expendable parts according to the travel distance of the vehicle V is stored in the storage region 12A of the server 12. The standard cost information acquisition section 46 acquires information regarding the standard maintenance cost of the expendable parts by referencing the data stored in the storage region 12A and the travel distance of the vehicle V.

The incentive awarding section 48 awards an incentive to the user of the vehicle V according to the acquired maintenance cost. Specifically, the incentive awarding section 48 awards an incentive according to a difference between the maintenance cost acquired by the maintenance cost information acquisition section 44 and the standard maintenance cost.

In the present exemplary embodiment as an example, the incentive awarding section 48 lowers a usage fee for the vehicle according to the acquired maintenance cost. Namely, the incentive awarding section 48 awards an incentive to the user by lowering the usage fee as the saving in the acquired maintenance cost compared to the standard maintenance cost increases.

Example of Incentive Awarding Processing

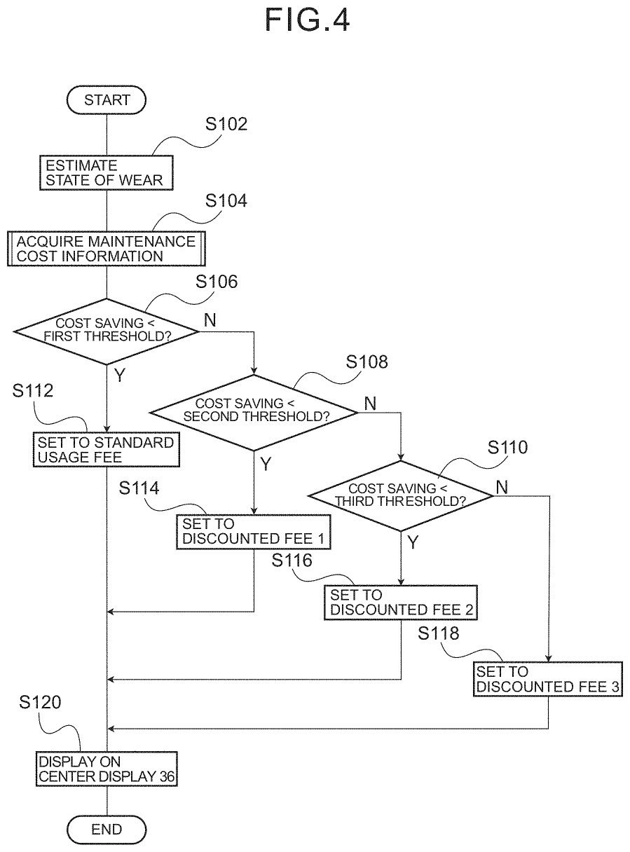

Explanation follows regarding an example of incentive awarding processing by the incentive awarding section 48, with reference to the flowchart illustrated in FIG. 4. The incentive awarding processing is executed by the CPU 20 reading the corresponding program from the ROM 22 or the storage 26 and expanding the program in the RAM 24. The incentive awarding processing is executed in cases in which the travel distance of the vehicle V has reached a predetermined distance, or in cases in which a predetermined usage period has elapsed. Note that although explanation follows regarding a case in which the expendable part is brake pads as an example, similar processing is performed for other expendable parts.

As illustrated in FIG. 4, at step S102, the CPU 20 estimates the state of wear of the brake pads configuring the expendable part. Specifically, the CPU 20 uses the functionality of the sensor information acquisition section 40 to acquire signals from the acceleration sensor or the brake pedal position sensor. The CPU 20 then estimates a state of wear of the brake pads by using the functionality of the wear state estimation section 42 to reference the data representing a relationship between the operation amount of the brake pedal and the state of wear. When this is performed, the wear state estimation section 42 may estimate an amount of abrasion of the brake pads from a relationship between a depression amount of the brake pedal based on the position sensor and a deceleration rate based on the acceleration sensor.

At step S104, the CPU 20 executes a maintenance cost information acquisition processing sub-routine from the state of wear of the brake pads. The maintenance cost information acquisition processing is described in detail later.

At step S106, the CPU 20 determines whether or not a cost saving in the maintenance cost compared to the standard maintenance cost is lower than a first threshold. Specifically, the CPU 20 uses the functionality of the standard cost information acquisition section to acquire the standard maintenance cost of the brake pads from the server 12 or the like. Note that the data regarding the standard maintenance cost of the brake pads is acquired according to the travel distance of the vehicle V. The CPU 20 then computes the cost saving in the brake pad maintenance cost acquired at step S104 compared to the standard maintenance cost of the brake pads.

In cases in which the cost saving is less than the first threshold, the CPU 20 transitions to the processing of step S112. At step S112, the CPU 20 sets the usage fee to a standard fee. Namely, the usage fee remains unchanged (the usage fee is not lowered) in cases in which the cost saving is less than the first threshold.

On the other hand, in cases in which the cost saving is the first threshold or above at step S106, the CPU 20 transitions to the processing of step S108. At step S108, the CPU 20 determines whether or not the cost saving is less than a second threshold.

In cases in which the cost saving is less than the second threshold, the CPU 20 transitions to the processing of step S114. At step S114, the CPU 20 sets the usage fee to a discounted fee 1.

On the other hand, in cases in which the cost saving is the second threshold or above at step S108, the CPU 20 transitions to the processing of step S110. At step S110, the CPU 20 determines whether or not the cost saving is less than a third threshold. In cases in which the cost saving is less than the third threshold, the CPU 20 transitions to the processing of step S116.

At step S116, the CPU 20 sets the usage fee to a discounted fee 2. In cases in which the cost saving is the third threshold or above at step S110, the CPU 20 transitions to the processing of step S118, whereupon the CPU 20 sets the usage fee to a discounted fee 3. Note that the discounted fee 1 is a fee with the lowest discount rate, whereas the discounted fee 3 is a fee with the highest discount rate. Thus, the greater the cost saving the lower the usage fee that the user has to pay.

At step S120, the CPU 20 displays the set usage fee on the center display 36 of the vehicle V. The incentive awarding processing is then ended.

Maintenance Cost Information Acquisition Processing

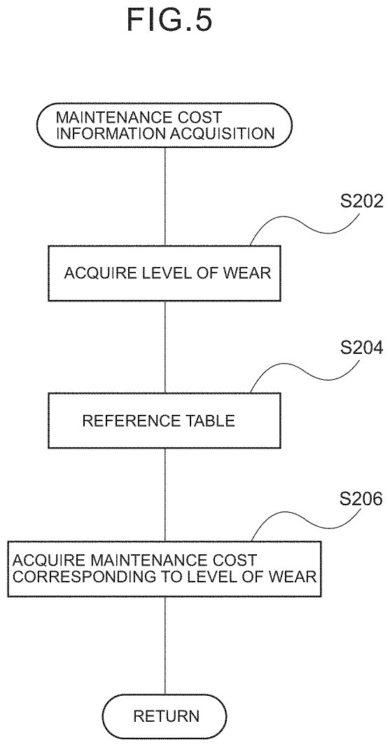

Next, explanation follows regarding the maintenance cost information acquisition processing subroutine, with reference to the flowchart in FIG. 5.

At step S202, the CPU 20 acquires the level of wear. Specifically, the CPU 20 acquires the level of wear of the brake pads as estimated by the wear state estimation section 42 from the storage region 12A of the server 12 or the like. As an example, the level of wear is a value between 0 and 100, 100 being a state of the brake pads prior to use and 0 being a worn state requiring brake pad replacement.

At step S204, the CPU 20 references a table stored in the storage region 12A of the server 12. Specifically, the CPU 20 references the table in which values for the level of wear of the brake pads and maintenance cost are associated with each other.

At step S206, the CPU 20 acquires the maintenance cost corresponding to the level of wear of the brake pads. The CPU 20 then ends the maintenance cost information acquisition processing subroutine.

Operation

Next, explanation follows regarding operation of the present exemplary embodiment.

In the vehicle management device 10 according to the present exemplary embodiment, the incentive awarding section 48 awards an incentive to the user of the vehicle V according to the acquired maintenance cost. This enables the user of the vehicle V to be encouraged to use expendable parts economically.

Moreover, in the vehicle management device 10 according to the present exemplary embodiment, the lower the acquired maintenance cost is compared to the standard maintenance cost, the greater the incentive awarded to the user. This enables the user of the vehicle V to be further encouraged to use expendable parts economically.

Furthermore, in the present exemplary embodiment, the usage fee for the vehicle V is lowered by the incentive awarding section 48, thereby enabling the incentive to be given without the user being aware. Moreover, by displaying the usage fee for the user to see, the user is able to indirectly ascertain the state of wear of the expendable parts.

Note that although a configuration in which the usage fee is lowered according to the cost saving has been described in the present exemplary embodiment, there is no limitation thereto. For example, a configuration in which points are awarded to the user according to the monthly cost saving may be adopted without changing the monthly usage fee. Explanation follows regarding an example of such a configuration, with reference to a flowchart.

### Modified Example

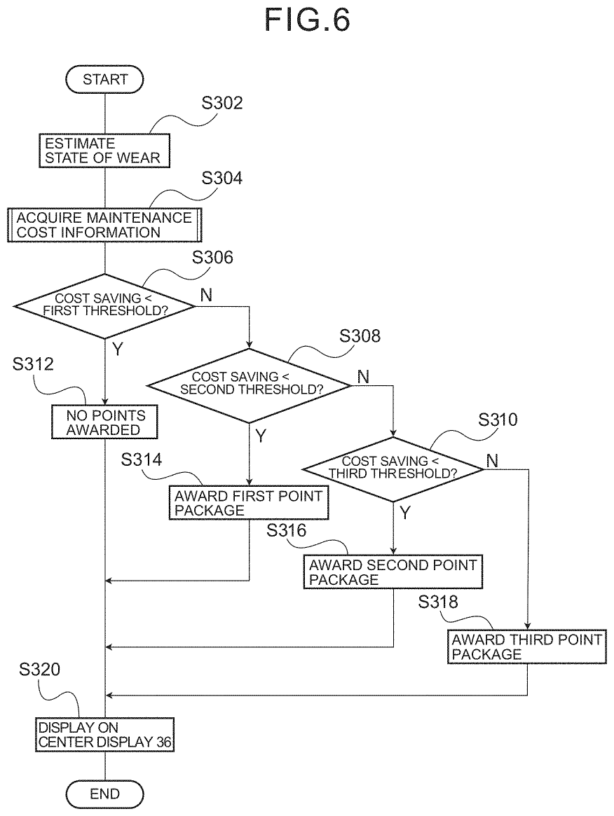

Explanation follows regarding an example of incentive awarding processing in the modified example, with reference to the flowchart illustrated in FIG. 6. The incentive awarding processing is executed by the CPU 20 reading the corresponding program from the ROM 22 or the storage 26 and expanding the program in the RAM 24.

As illustrated in FIG. 6, the processing of steps S302, S304, S306, S308, and S310 is substantially the same as the processing of steps S202, S204, S206, S208, and S210 in FIG. 5, and so explanation thereof is omitted.

In cases in the cost saving is less than the first threshold at step S306, the CPU 20 transitions to the processing of step S312. At step S312, the CPU 20 does not award any points. Namely, points are not awarded in cases in which the cost saving is less than the first threshold.

In cases in which the cost saving is less than the second threshold at step S308, the CPU 20 transitions to the processing of step S314. At step S314, the CPU 20 awards a first point package.

In cases in which the cost saving is less than the third threshold at step S310, the CPU 20 transitions to the processing of step S316. At step S316, the CPU 20 awards a second point package. On the other hand, in cases in which the cost saving is the third threshold or above, the CPU 20 transitions to the processing of step S318, whereupon the CPU 20 awards a third point package. Note that the first point package contains the least number of points, whereas the third point package contains the greatest number of points to be awarded to a user. Thus, the greater the cost saving the more points are awarded in the incentive awarding processing of the modified example. At step S320, the CPU 20 displays the points awarded on the center display 36 of the vehicle V. The incentive awarding processing is then ended.

The points awarded to the user may be used to cover part of the cost when purchasing predetermined goods. Alternatively, the points may be exchanged for predetermined goods. As another alternative, the points may be used to cover part or all of the usage fee.

Although the vehicle management device 10 according to an exemplary embodiment and a modified example has been described above, obviously various modifications may be implemented within a range not departing from the spirit of the present disclosure. For example, although a configuration in which the usage fee is lowered in stages according to the cost saving has been described in the above exemplary embodiment, there is no limitation thereto. For example, the amount saved may be reflected in the discount rate.

Moreover, although a configuration in which points are awarded has been described in the modified example, there is no limitation thereto. A system such as a mileage scheme in which miles are collected may be applied. In such cases, configuration may be such that a special incentive is awarded when more than a specific number of miles have been collected.

Although an configuration in which the processing performed by the vehicle management device 10 employs cloud computing has been described in the above exemplary embodiment, there is no limitation thereto. For example, a distributed processing method such as edge computing may be employed.

Furthermore, although the wear state estimation section 42 outputs a value between 0 and 100 for each of the expendable parts, 100 being a state prior to use and 0 being a state requiring replacement, in the above exemplary embodiment, there is no limitation thereto. For example, management may be performed using a greater range of values. Alternatively, management may be performed using an index other than values.

Note that the processing executed by the CPU 20 reading and executing programs in the above exemplary embodiment may be executed by various types of processors other than the CPU 20. Such processors include programmable logic devices (PLDs) that allow circuit configuration to be modified post-manufacture, such as a field-programmable gate array (FPGA), and dedicated electric circuits, these being processors including a circuit configuration custom-designed to execute specific processing, such as an application specific integrated circuit (ASIC). Moreover, the incentive awarding processing may be executed by any one of these various types of processors, or by a combination of two or more of the same type or different types of processors, such as plural FPGAs, or a combination of a CPU and an FPGA. The hardware structure of these various types of processors is more specifically an electric circuit combining circuit elements such as semiconductor elements.

Although a configuration in which various data is stored in the storage 26 has been described in the above exemplary embodiment, there is no limitation thereto. For example, a storage section may be configured by a non-transitory recording medium such as a compact disc (CD), a digital versatile disc (DVD) or universal serial bus (USB) memory. In such cases, various programs, data, and so on are held on the recording medium.

What is claimed is:

1. A vehicle management device comprising a processor, the processor being configured to:
acquire information from a sensor unit installed at a vehicle to be used by a user through a subscription service;
estimate a state of wear of an expendable part of the vehicle from the acquired information;
acquire information regarding a maintenance cost of the expendable part from the estimated state of wear of the expendable part; and
award an incentive to the user of the vehicle according to the acquired maintenance cost information.

2. The vehicle management device of claim 1, wherein the processor is configured to:
acquire information regarding a preset standard maintenance cost of the expendable part preset for each travel distance of the vehicle; and
award the incentive according to a difference between the acquired maintenance cost and the standard maintenance cost.

3. The vehicle management device of claim 1, wherein the processor is configured to lower a usage fee for the vehicle according to the acquired maintenance cost.

4. The vehicle management device of claim 1, wherein the processor is configured to award points according to the acquired maintenance cost.

5. The vehicle management device of claim 1, wherein the processor is configured to display the incentive awarded to the user on a display device inside a vehicle cabin of the vehicle, or on a portable terminal of the user.

6. The vehicle management device of claim 1, wherein the processor is configured to estimate an operation amount of a brake pedal configuring the expendable part and an operation duration of the brake pedal based on information from a vehicle speed sensor or an acceleration sensor.

7. The vehicle management device of claim 1, wherein the processor is configured to refer to information from a GPS sensor and to road surface data for a road traveled, and to estimate that wear of an air cleaner configuring the expendable part is more advanced in a case in which the road traveled is an unsurfaced road than in a case in which the road traveled is a surfaced road.

8. A vehicle management method comprising, by a processor:
acquiring information from a sensor unit installed at a vehicle to be used by a user through a subscription service;
estimating a state of wear of an expendable part of the vehicle from the acquired information;
acquiring information regarding a maintenance cost of the expendable part from the estimated state of wear of the expendable part; and
awarding an incentive to the user of the vehicle according to the acquired maintenance cost.
